(19) United States
(12) Patent Application Publication
(10) Pub. No.: US 2004/0220067 A1
(43) Pub. Date: Nov. 4, 2004

(54) Lavatory bowl rim-block

(76) Inventors: Maria Papadaki, Meise (GR); Vincenzo Tomarchio, Brussel (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/834,559

(22) Filed: Apr. 29, 2004

(30) Foreign Application Priority Data
Apr. 29, 2003 (EP) 03447098.9

(51) Int. Cl. C11D 1/00

(52) U.S. Cl. 510/190; 510/191

(57) ABSTRACT

The present invention encompasses a lavatory bowl rim-block dispensing a solution comprising a silicone polymer and a chelant onto a lavatory bowl surface.

### CROSS REFERENCE TO RELATED APPLICATIONS

This application claims the benefit of the filing date of EPO application serial no. 03447098.9 filed Apr. 29, 2003.

### TECHNICAL FIELD

The present invention relates to lavatory bowl rim-blocks.

### BACKGROUND

A great variety of ways to clean lavatory bowls, such as toilet bowls, has been described in the art. One particular way of cleaning lavatory bowls, such as toilet bowls, are so called rim-blocks. Indeed, rim-blocks are devices that dispense liquid or solid compositions directly into a lavatory bowl from under the rim of said bowl. Such rim-blocks are usually attached by various means, such as hooks and the like, to the rim of the lavatory bowl. Every time a toilet equipped with a rim-block is flushed, an amount of composition is dispensed into the lavatory bowl. Liquid and solid rim-blocks are already known in the art.

The present invention relates to so-called liquid rim-blocks, this means the composition to be released into the lavatory bowl are in liquid form.

Examples of liquid rim-blocks known in the art include a liquid rim-block device having a suspension means and at least two compartments for active substances (WO 02/40792), or a lavatory cleaning system comprising a dispenser for dispensing a liquid composition from under the rim of a lavatory bowl, wherein the composition has a viscosity of greater than 2500 mPa s (WO 02/04951). Other similar systems are described in EP 775741 or WO 01/94520.

Even though, the currently known lavatory bowl rim-block according to the above cited art provide a good performance with regard to cleaning performance, it has been found by consumer research that the shine performance of the existing lavatory bowl rim-blocks can be further improved.

Indeed, consumers are looking for lavatory bowl rim-blocks that keep a lavatory bowl, in particular a toilet bowl, shiny over a significant number of rinse-dry cycles (i.e., toilet flushes). Indeed, mineral encrustation, such as limescale deposits, is formed on the lavatory bowl surface after each flush. In addition, dirt can be trapped in these encrustations. The encrustations and the dirt entrapped therein reduce the shine of the lavatory bowl over time.

It is therefore an objective of the present invention to provide a lavatory bowl rim-block comprising at least one liquid composition, wherein said lavatory bowl rim-block provides excellent shine performance to the surface treated with the said liquid composition.

It has now been found that the above objective can be met by a lavatory bowl rim-block according to the present invention.

Advantageously, the lavatory bowl rim-blocks as described herein may be used to clean surfaces made of a variety of materials like glazed and non-glazed ceramic tiles, enamel, stainless steel, Inox®, Formica®, vinyl, no-wax vinyl, linoleum, melamine, glass, plastics and plastified wood.

A further advantage of the present invention is that the compositions according to the present invention have the ability to provide long lasting shine to the surface they have cleaned.

### SUMMARY OF THE INVENTION

The present invention encompasses a lavatory bowl rim-block comprising: at least one liquid composition; and a dispenser, said dispenser comprising at least one container and a dispensing means connected to at least one of said container(s) for dispensing a single liquid composition or a combination of compositions onto a lavatory bowl surface; wherein said single liquid composition or said combination of compositions dispensed onto said lavatory bowl surface comprises a silicone polymer and a chelant.

The present invention further encompasses a lavatory bowl rim-block comprising: at least one liquid composition; and a dispenser, said dispenser comprising at least one container and a dispensing means connected to said container(s) for dispensing said liquid composition onto a lavatory bowl surface; wherein said single liquid composition dispensed onto said lavatory bowl surface comprises gellan gum.

### DETAILED DESCRIPTION OF THE INVENTION

Surfaces to be Cleaned

The lavatory bowl rim-block herein is used to clean the surface or at least parts thereof of a lavatory bowl, such as a toilet bowl, urinals and the like. Preferably, the lavatory bowl rim-block herein is used to clean the surface or at least parts thereof of the inside portion of a lavatory bowl, such as a toilet bowl, urinals and the like. More preferably, the lavatory bowl rim-block herein is used to clean at least parts of the inside portion of a toilet bowl or a urinal, preferably a toilet bowl.

The lavatory bowl rim-block herein may be used to clean lavatory bowl surfaces made of different materials like ceramic, enamel, vinyl, no-wax vinyl, linoleum, melamine, glass, Inox®, Formica®, any plastics, plastified wood, metal or any painted or varnished or sealed surface and the like.

Lavatory Bowl Rim-Block

The lavatory bowl rim-block herein comprises: at least one liquid composition; and a dispenser, said dispenser comprising at least one container and a dispensing means connected to at least one of said container(s) for dispensing a single liquid composition or a combination of liquid compositions onto a lavatory bowl surface.

Preferably, the lavatory bowl rim-block herein dispenses at least one liquid composition from the rim portion of a lavatory bowl onto the lavatory bowl surface.

The lavatory bowl rim-block herein is preferably designed such that a sufficient amount of the liquid composition(s) herein is transferred to the lavatory bowl upon flushing of the lavatory bowl with water.

In a preferred embodiment, the lavatory bowl rim-block herein is a toilet rim-block.

The Dispenser

The lavatory bowl rim-block of the present invention is preferably made of two main parts: a) at least one liquid composition; and b) a dispenser. Said dispenser of the lavatory bowl rim-block comprises at least one container and a dispensing means connected to at least one of said container(s) for dispensing a single liquid composition or a combination of liquid compositions onto a lavatory bowl surface. The at least one liquid composition is contained in the at least one container of the dispenser.

The container herein may by any suitable container to hold a liquid composition. Indeed, suitable containers herein include, but are not limited to bottles, jars, pouches, boxes, sachets and the like. Preferably, said container has at least one opening. The container is preferably made by blow molding of thermoplastic material, more preferably a material selected from group consisting of Polyethylene Terephthalate (PET), Polyethylene Terephthalate-G (PETG), Polyvinyl Chloride (PVC), Polypropylene (PP), Polystyrene (PS), High Impact Polystyrene (HIPS), Polyvinylidene Chloride (PVDC), and mixtures thereof.

In a preferred embodiment herein, the container of the lavatory bowl rim-block is refillable and/or replaceable. Indeed, the container as a whole may be replaced once it is empty (replaceable) or the composition may be refilled into the existing container. The container may be refilled through an aperture in the container with the composition provided in a separate container, such as a bottle.

The dispensing means herein may by any suitable means to dispense at least one liquid composition onto a lavatory bowl surface. The lavatory bowl rim-block may comprise one or a multitude of dispensing means. Suitable means to dispense at least one liquid composition onto a lavatory surface are apertures, spray heads, trays, pads with or without capillary channels, plates with or without capillary channels, blotter type dispensing means such as described in EP 775 741, and the like. In the preferred embodiment wherein the lavatory bowl rim-block herein is used to clean the inside portion of a lavatory bowl or at least parts thereof, the dispensing means herein comes into contact with water used to flush said lavatory bowl. In this preferred embodiment, the water used to flush said lavatory bowl mixes with at least one liquid composition of the lavatory bowl rim-block herein and thereby delivers the composition(s) onto the lavatory bowl surface. The dispensing means herein is connected to at least one of said container(s) by any suitable means, such as pipes, tubes, and the like, and may further contain valves, mixing chambers, shutters, and the like.

The dispenser as described above may comprise other elements such as: an attachment means; a supporting structure, holding the different elements of the dispenser together; blinds, used for aesthetics or to regulated water flow; wings, used to regulated water flow; etc. In a preferred embodiment herein, the lavatory bowl rim-block, preferably said dispenser, additionally comprises an attachment means. Said attachment means is used to connect the lavatory bowl rim-block, preferably the dispenser, to said lavatory bowl and hold it in place over its lifetime. Suitable attachment means are selected from the group consisting of: hooks, a suction cup or a set thereof, an adhesive, and mixtures thereof. Preferably said attachment means attaches the dispenser to the rim or suspends the dispenser from said rim. In a preferred embodiment said attachment means is a hook to suspend the dispenser from the rim of a lavatory bowl.

Preferably, the dispenser herein additionally comprises an attachment means. More preferably, the dispenser herein additionally comprises an attachment means and a supporting structure.

In a preferred embodiment of the present invention, wherein the lavatory bowl rim-block comprises one container, the lavatory bowl rim-block comprises one liquid composition comprising all the essential ingredients of said composition (“single compartment liquid rim-block” or “single compartment dispenser”).

In another preferred embodiment herein, wherein the lavatory bowl rim-block comprises more than one container, preferably two to four, more preferable two to three, most preferably two containers, the essential ingredients of the liquid composition(s) (hereinafter “essential ingredients”) of the lavatory bowl rim-block, may be present together in one and the same liquid composition contained in one of the container or these essential ingredients of the composition(s) of the lavatory bowl rim-block, may in separate compositions contained in different containers, wherein preferably one of said separate compositions is a liquid composition and the other composition(s) are liquid, gel or solid compositions more preferably the other composition(s) are liquid compositions.

In the case where these essential ingredients of the composition(s) of the lavatory bowl rim-block, are in separate compositions contained in different containers, the compositions containing the essential ingredients are dispensed as a combination of compositions. By “combination of compositions” it is meant that the various compositions comprising the essential ingredients are mixed or at least combined: prior to being dispensed, e.g. in a mixing chamber, if any, or the dispensing means; during the dispensing, e.g., on the dispensing means; or after being dispensed, on the lavatory surface itself (this means in the flushed water). Indeed, at least the containers containing essential ingredients are connected to the dispensing means or a multitude thereof in way that the compositions containing the essential ingredients are dispensed onto said lavatory bowl surface.

In the embodiment of the present invention, wherein the lavatory bowl rim-block comprises at least one solid and/or gel composition(s), it may be necessary for the flush water to dissolve or wash away said solid and/or gel composition(s). This can be achieved by, e.g., providing a container containing said solid and/or gel composition(s) that is water permeable using openings, slits, and the like, or even water soluble.

In the preferred embodiment, wherein the lavatory bowl rim-block comprises more than one container, as described above, the container(s) not comprising essential ingredients are not necessarily used to dispense compositions onto said lavatory bowl surface, however it is in the scope of the present invention that such a container(s) also dispense compositions onto the lavatory bowl surface. Indeed, such a container(s) may contain compositions, such as perfumes and the like, that are dispensed into the air. Furthermore, such containers may contain liquid and/or solid compositions.

Suitable dispensers for use in the lavatory bowl rim-block as described herein are for example described in WO 01/44591, WO 99/66140, GB 2345494, WO 99/15375, WO 00/49238, GB 2358028, WO 95/38637, WO 01/77451, WO 00/42261, WO 01/06067, EP 538957, U.S. Pat. No. 6,230,334, EP 1046756 and WO 01/02653.

Composition(s)

At least one of the compositions of the lavatory bowl rim-block as described herein are formulated as liquid composition(s). The term liquid composition encompasses aqueous, thickened, gel and pasteous composition.

In a preferred embodiment herein, the compositions herein are thickened compositions. The thickened compositions herein may be in the form of a gel or a pasteous composition.

If more than one composition is present in the lavatory bowl rim-block herein, said compositions may have different theologies and/or pH. Indeed, preferably one of said separate compositions is a liquid composition and the other composition(s) are liquid, gel or solid compositions more preferably the other composition(s) are liquid compositions.

Preferred thickened compositions of the present invention have a viscosity of 2 cps or greater, more preferably of from 2 to 5000 cps, and still more preferably of from 100 to 3500 cps at 20° C. when measured with a Carri-Med Rheometer model CSL² 100® (Supplied by TA Instruments) with a 4 cm conic spindle in stainless steal (linear increment from 0.1 to 100 sec⁻¹ in max. 8 minutes).

It is at these preferred viscosities where the thickened compositions herein show a good distribution of the composition over the surface to be cleaned as well as an adherence to said surface sufficient to stick to the surface during the cleaning operation itself.

Preferred liquid compositions herein comprise water in an amount of from 0.01% to 90%, even more preferably of from 2% to 70% and most preferably 5% to 60% by weight of the total composition.

In another preferred embodiment, the liquid compositions herein are substantially free of water, preferably free of water. By “substantially free of water” it is meant that no water as such is added to the liquid composition(s). However, said liquid composition(s) may comprise traces of water added into the composition(s) through the raw-materials used to produce the liquid composition(s). The level of water added into the composition(s) through the raw-materials used to produce the liquid composition(s) is preferably below 10%, more preferably below 5%, even more preferably below 3% by weight of the total composition.

The pH of the liquid composition according to the present invention may typically be from 0 to 14.

Preferably, the pH of the liquid compositions herein, as is measured at 25° C., is at least, with increasing preference in the order given, 2, 3, 4, 5, or 5.9. Independently, the pH of the thickened compositions herein, as is measured at 25° C., preferably is no more than, with increasing preference in the order given, 14, 13, 12, 11, 10, 9, 8, 7 or 6.1. Accordingly, the compositions herein may further comprise an acid or base to adjust pH as appropriate.

Acidity, if present, may further contribute to formulate compositions according to the present invention that exhibit good limescale removing performance whilst exhibiting also good disinfecting properties.

Suitable acids herein may be organic and/or inorganic acids. Particularly suitable organic acids to be used herein are aryl and/or alkyl sulfonate, such as methane sulphonic acids, citric acid, succinic acid, sulphamic acid, maleic acid and the like. Particularly suitable inorganic acids are sulfuric, phosphoric, nitric acids and the like.

A typical level of acid, when present, is of from 0.0001% to 15%, preferably from 0.001% to 10% and more preferably from 0.01% to 7% by weight of the total composition.

Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate and hydrogen carbonate.

Typical levels of a base, when present, are of from 0.001% to 5% by weight, preferably from 0.01% to 3% and more preferably from 0.1% to 2% by weight of the composition.

Chelant

The single liquid composition or combination of liquid compositions dispensed onto said lavatory bowl surface according to the present invention comprise a chelant as an essential ingredient.

Suitable chelants may be any of those known to those skilled in the art, such as the ones selected from the group comprising phosphonate chelants, amino carboxylate chelants, other carboxylate chelants, polyfunctionally-substituted aromatic chelants, ethylenediamine N,N′-disuccinic acids, or mixtures thereof.

Suitable phosphonate chelants to be used herein may include ethane 1-hydroxy diphosphonates (HEDP) or salts thereof, alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelants to be used herein are diethylene triamine penta methylene phosphonate (DTPMP) and ethane 1-hydroxy diphosphonate (HEDP). Such phosphonate chelants are commercially available from Monsanto under the trade name DEQUEST®.

Preferably, the chelant herein is a phosphonate chelant or a mixture thereof. More preferably, the chelant herein is selected from the group consisting of ethane 1-hydroxy diphosphonates (HEDP) or salts thereof, alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP) and mixtures thereof. Most preferably, the chelant herein is ethane 1-hydroxy diphosphonate (HEDP) or a salt thereof.

Polyfunctionally-substituted aromatic chelants may also be useful in the compositions herein. See U.S. Pat. No. 3,812,044, issued May 21, 1974, to Connor et al. Preferred chelants of this type in acid form are dihydroxydisulfobenzenes such as 1,2-dihydroxy-3,5-disulfobenzene.

A preferred biodegradable chelant for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer, have been extensively described in U.S. Pat. No. 4,704,233, Nov. 3, 1987, to Hartman and Perkins. Ethylenediamine N,N′-disuccinic acid is, for instance, commercially available under the tradename ssEDDS® from Palmer Research Laboratories.

Suitable amino carboxylates to be used herein as chelants include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelants to be used herein include salicylic acid, aspartic acid, glutamic acid, glycine, malonic acid or mixtures thereof.

Another chelant for use herein is of the formula:

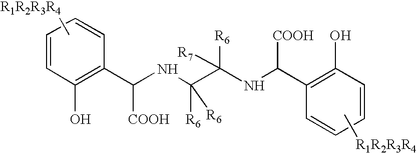

wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Typically, the composition(s) herein may comprise up to about 5%, preferably from about 0.1% to about 3% by weight and more preferably from about 0.5%% to about 2% by weight of the total composition of a chelant.

Silicone Polymer

The single liquid composition or combination of liquid compositions dispensed onto said lavatory bowl surface according to the present invention comprise a silicone polymer as an essential ingredient.

The composition(s) herein may comprise up to 50%, more preferably of from 0.01% to 30%, even more preferably of from 0.01% to 20%, and most preferably of from 0.01% to 10%, by weight of the total composition of said silicone polymer.

Suitable silicone polymers are selected from the group consisting of silicone glycol polymers and mixtures thereof.

In a preferred embodiment according to the present invention, the silicone polymer herein is a silicone glycol polymer.

Depending on the relative position of the silicone-polyether chains, the silicone glycol polymer can be either linear or grafted.

Preferably, said silicone glycol polymer is according to the following formulae:

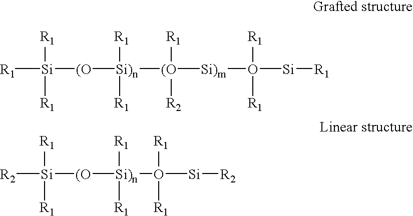

wherein: each R₁ independently is H or a hydrocarbon radical; R₂ is a group bearing a polyether functional group; n is an integer of from 0 to 500; and for the grafted structure m is an integer of from 1 to 300, and preferably with n+m more than 1.

In a highly preferred embodiment herein the silicone polymer herein is a grafted silicone glycol.

Preferably, each R₁ independently is H or a hydrocarbon chain comprising from 1 to 16, more preferably a hydrocarbon chain comprising from 1 to 12 carbon atoms, and even more preferably R₁ is a CH₃-group. R₁ can also contain NH₂ groups and/or quaternary ammoniums.

Preferably, n is an integer of from 0 to 100, more preferably an integer of from 1 to 100, even more preferably n is an integer of from 1 to 50, and most preferably n is an integer of from 5 to 30.

Preferably, m (for the grafted structure) is an integer of from 1 to 80, more preferably m is an integer of from 1 to 30, and even more preferably m is an integer of from 2 to 10. Preferably, n+m is more than 2.

Preferably, R₂ is an alkoxylated hydrocarbon chain. More preferably, R₂ is according to the general formulae:

—R₃-(A)ₚ-R₄ or -(A)ₚ-R₄

wherein: R₃ is a hydrocarbon chain; A is an alkoxy group or a mixture thereof; p is an integer of from 1 to 50; and R₄ is H or a hydrocarbon chain, or —COOH.

Preferably, R₃ is a hydrocarbon chain comprising from 1 to 12, more preferably 3 to 10, even more preferably from 3 to 6, and most preferably 3 carbon atoms.

Preferably, A is an ethoxy or propoxy or butoxy unit or a mixture thereof, more preferably A is an ethoxy group.

Preferably, p is an integer of from 1 to 50, more preferably p is an integer of from 1 to 30, and even more preferably p is an integer of from 5 to 20.

Preferably, R₄ is H or a hydrocarbon chain comprising from 1 to 12, more preferably 1 to 6, even more preferably from 3 to 6, and still even preferably 3 carbon atoms, most preferably R₄ is H.

Preferably, the silicone glycol polymers suitable herein have an average molecular weight of from 500 to 100,000, preferably from 600 to 50,000, more preferably from 1000 to 40,000, and most preferably from 2,000 to 20,000.

Suitable, silicone glycol polymers are commercially available from General electric, Dow Corning, and Witco under the following tradenames:

| GE Bayer Silicones: | Dow Corning: | Witco: |
|---|---|---|
| SF 1488 ® | DC 8692 ® | L-77 ® |
| SF 1288 ® | Q4-3667 ® | L-7001 ® |
| SF 1388 ® | DC 5067 ® | L-7087 ® |
| SF 1328 ® | DC 1248 ® | L-7200 ® |
| SF 1528 ® | DC 3225C ® | L-7210 ® |
| SF 1188 ® | DC 5225C ® | L-7220 ® |
| TP 3799 ® | DC 190 ® | L-7230 ® |
| TP 3800 ® | DC 5247 ® | L-7280 ® |
| TP 3801 ® | FF 400 ® | L-7500 ® |
| TP 3804 ® | DC 5329 ® | L-7510 ® |
| TP 3805 ® | DC 5220 ® | L-7550 ® |
| TP 3806 ® | DC 5097 ® | L7600 ® |
| TSF 4440 ® | DC 5604 ® | L-7602 ® |
| TSF 4441 ® | DC 5197 ® | L-7604 ® |
| TSF 4445 ® | DC 5103 ® | L-7605 ® |
| TSF 4446 ® | DC 5093 ® | L-7607 ® |
| TSF 4452 ® | DC 5237 ® | L-7608 ® |
| TSF 4460 ® | DC 5098 ® | L-7622 ® |
| TSF 4450 ® | DC 193 ® | L-7644 ® |
| AI 3669 ® | DC 5200 ® | L-7650 ® |
| AI 3465 ® | Sylgard 309 | L-7657 ® |
| AI 3466 ® | DC 5211 ® | L-8500 ® |
| AI 3467 ® | DC 5212 ® | L-8600 ® |
| AI 3468 ® | | L-8610 ® |
| | | L-8620 ® |

In a highly preferred embodiment according to the present invention, the polymer herein is a Silicones-Polyethers copolymer, commercially available under the trade name SF 1288® from GE Bayer Silicones.

It has now been found, that the silicone polymers as described herein deposits onto the surfaces cleaned with a composition according to the present invention. Thereby, soil adherence, limescale and/or mineral encrustation build-up, is prevented.

A known problem with the currently available lavatory bowl rim-block is their limited ability to keep lavatory bowls shiny (“shine benefit”) over a significant number of rinse-dry cycles (i.e., toilet flushes). Indeed, mineral encrustation, such as limescale deposits, is formed on the lavatory bowl surface after each flush. In addition, dirt can be trapped in these encrustations. The encrustations and the dirt entrapped therein reduce the shine of the lavatory bowls over time. The liquid composition(s) herein provides a mineral encrustation prevention benefit and shine/gloss by reducing or even preventing mineral deposition on the lavatory bowl surface.

The Applicant has found that the (repeated) application of a composition or the combined (repeated) application of compositions comprising a silicone polymer and a chelant as described herein onto a lavatory bowl surface, significantly reduce or even prevent the formation mineral deposition on said lavatory bowl surface. By reducing or even preventing the formation mineral deposition on said lavatory bowl surface the encrustation of said minerals as well as the entrapment of dirt therein is reduced or even prevented, thereby the original shine of said lavatory bowl surface is protected. Indeed, the lavatory bowl surface remains shiny over a prolonged period of time, this means over a significant number of rinse-dry cycles (i.e., toilet flushes).

Without being bound by theory, it is believed that this reduction or even prevention of the formation mineral deposition on said lavatory bowl surface is due to the increased hydrophobicity after the (repeated) application of a composition or the combined (repeated) application of compositions comprising a silicone polymer and a chelant as described herein. Indeed, it has been found, that the silicone polymers as described herein, deposits onto the lavatory bowl surface, which is thereby rendered less prone the adherence and/or the build-up of limescale and mineral encrustation, etc. (“mineral deposition”). Furthermore, it has been found that the presence of a chelant herein further significantly reduces the mineral deposition by chelating ions of the mineral deposition.

The shine benefit as described herein of a given composition can be determined by measuring gloss on black glossy tiles (SENIO®) and using either untreated (new) black glossy tiles or black glossy tiles treated with tab-water as a reference. Indeed, 20 cm×20 cm black glossy tiles are rinsed for 15 sec with a composition containing 3 ppm of a surface modifying polymer in tap-water. Subsequently these tiles are left to dry and subsequently the rinse/dry cycle is repeated for at least 10 times and up to 120 times. Thereafter, gloss is measured by the Tri MicroGloss 20-60-86 Instrument® (Sheen Instruments) by taking 10 measurements of each tile. The reference tiles are treated normal tab-water only for 15 sec every time and undergo the same amount of rinse/dry cycles. The gloss of the reference tiles (either treated with water or the new tiles) is measured by the Tri MicroGloss 20-60-86 Instrument® (Sheen Instruments) by taking 10 measurements of each tile.

Processes

The present invention encompasses a process of cleaning a lavatory bowl surface with a lavatory bowl rim-block according to the present invention, wherein said process comprises the step of applying a single liquid composition or a combination of liquid compositions onto a lavatory bowl surface.

Preferably, said application of a single liquid composition or a combination of liquid compositions onto a lavatory bowl surface is done upon flushing said lavatory bowl surface with water.

In said process of cleaning a lavatory bowl surface with a lavatory bowl rim-block according to the present invention the liquid composition(s) are applied onto said lavatory bowl surface in diluted form.

By “in its diluted form” it is meant herein that said composition(s) may be diluted with water up to 120.000× dilution level, preferably between 50.000× to 80.000×, more preferably 10.000× to 60.000×, even more preferably 10.000× to 55.000×, and most preferably 20.000× to 50.000× dilution level. Said dilution occurs upon application of the liquid composition herein or the combination of the liquid compositions herein to said surface.

Furthermore, the present invention encompasses the manufacture of a composition for use in one of the processes as described herein above.

Optional Ingredients in the Compositions Herein

Nonionic Surfactants

The single liquid composition or combination of liquid compositions dispensed onto said lavatory bowl surface according to the present invention may comprise, as an optional ingredient but highly preferred ingredient a nonionic surfactant, or mixtures thereof.

Accordingly, the composition(s) herein may comprise up to 70%, preferably of from 1% to 30%, more preferably of from 1% to 20%, and most preferably of from 1% to 10% by weight of the total composition of a nonionic surfactant or mixtures thereof.

The presence of nonionic surfactants in the composition(s) of the present invention allows to provide good cleaning performance. The presence of nonionic surfactants in the composition(s) herein may also allow to provide compositions with further improved shine benefit. Indeed, it has been found that the presence of a nonionic surfactant further contributes to the reduction or even prevention of mineral deposits as described herein above.

Suitable nonionic surfactants to be used herein are alkoxylated fatty alcohol nonionic surfactants that can be readily made by condensation processes that are well known in the art. Indeed, a great variety of such alkoxylated fatty alcohols are commercially available which have very different HLB values. The HLB values of such alkoxylated nonionic surfactants depend essentially on the chain length of the fatty alcohol, the nature of the alkoxylation and the degree of alkoxylation. Hydrophilic nonionic surfactants tend to have a high degree of alkoxylation and a short chain fatty alcohol, while hydrophobic surfactants tend to have a low degree of alkoxylation and a long chain fatty alcohol. Surfactants catalogues are available which list a number of surfactants including nonionics, together with their respective HLB values.

Accordingly, preferred alkoxylated alcohols for use herein are nonionic surfactants according to the formula RO(E)ₑ(P)ₚH where R is a hydrocarbon chain of from 2 to 24 carbon atoms, E is ethylene oxide and P is propylene oxide, and e and p which represent the average degree of, respectively ethoxylation and propoxylation, are of from 0 to 24. The hydrophobic moiety of the nonionic compound can be a primary or secondary, straight or branched alcohol having from 8 to 24 carbon atoms. Preferred nonionic surfactants for use in the compositions according to the invention are the condensation products of ethylene oxide with alcohols having a straight alkyl chain, having from 6 to 22 carbon atoms, wherein the degree of ethoxylation is from 1 to 15, preferably from 5 to 12. Such suitable nonionic surfactants are commercially available from Shell, for instance, under the trade name Dobanol® or from Shell under the trade name Lutensol®. These nonionics are preferred because they have been found to allow the formulation of a stable product without requiring the addition of stabilisers or hydrotropes. When using other nonionics, it may be necessary to add hydrotropes such as cumene sulphonate or solvents such as butyldiglycolether.

Other Surfactants

The single liquid composition or combination of liquid compositions dispensed onto said lavatory bowl surface according to the present invention may further comprise a surfactant other than the nonionic surfactant, if any, as described above.

All types of surfactants may be used in the present invention including anionic, cationic, amphoteric or zwitterionic surfactants. It is also possible to use mixtures of such surfactants without departing from the spirit of the present invention.

The presence of surfactants other than the nonionic surfactants in the composition(s) of the present invention allows to provide good cleaning performance.

Accordingly, the liquid composition(s) herein may comprise up to 70%, preferably of from 0.1% to 60%, more preferably of from 1% to 50%, and most preferably of from 5% to 40% by weight of the total composition of a surfactant, or mixtures there.

Suitable amphoteric surfactants to be used in the compositions according to the present invention include amine oxides. Preferred long chain amine oxides for use herein are for instance natural blend C₈-C₁₀ amine oxides as well as C₁₂-C₁₆ amine oxides commercially available from Hoechst. Preferred short chain amine oxides for use herein are for instance natural blend C₈-C₁₀ amine oxides available from Hoechst.

In a highly preferred embodiment according to the present invention, the single liquid composition or combination of liquid compositions dispensed onto said lavatory bowl surface according to the present invention may further comprise an alkyl alkoxylated sulphate surfactant. Suitable alkyl alkoxylated sulphate surfactants for use herein are according to the formula RO(A)ₘSO₃M wherein: R is a substituted or unsubstituted, linear or branched C₆-C₂₄, preferably a C₈-C₂₀, more preferably a C₁₂-C₂₀, even more preferably a C₁₂-C₁₈, and most preferably a C₁₂-C₁₄ alkyl group; A is an ethoxy or propoxy or butoxy unit; m is greater than zero, preferably at least 0.1, more preferably between 0.1 and 15, even more preferably between 0.5 and 6, and most preferably between 0.5 and 4; and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates and alkyl butoxylated sulfates are contemplated herein. Highly preferred herein as alkyl alkoxylated sulphate surfactants are alkyl ethoxylated sulfates, i.e., A is an ethoxy group. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine isopropanolamine, mixtures thereof, and the like. Exemplary surfactants are C₁₂-C₁₈ alkyl polyethoxylate (1.0) sulfate (C₁₂-C₁₈E(1.0)SM), C₁₂-C₁₈ alkyl polyethoxylate (2.25) sulfate (C₁₂-C₁₈E(2.25)SM), C₁₂-C₁₈ alkyl polyethoxylate (3.0) sulfate (C₁₂-C₁₈E(3.0)SM), C₁₂-C₁₄ alkyl polyethoxylate (3.0) sulfate (C₁₂-C₁₄E(3.0)SM) and C₁₂-C₁₈ alkyl polyethoxylate (4.0) sulfate (C₁₂-C₁₈E(4.0)SM), wherein M is conveniently selected from sodium and potassium. Of particular importance herein is an alkyl ethoxylated sulfate with a degree of ethoxylation of 2.4 or between 2-3. Sodium C₁₂/C₁₄ E3 sulphate may be for example commercially available from Albright & Wilson under the name EMPICOL ESC3®.

When present, alkyl alkoxylated sulphate surfactants contribute to suds stability, and volume and also contribute to product viscosity.

Solvent

The single liquid composition or combination of liquid compositions dispensed onto said lavatory bowl surface according to the present invention may further comprise a solvent.

Accordingly, the composition(s) herein may comprise up to 30%, preferably of from 0.1% to 30%, more preferably of from 1% to 20%, and most preferably of from 1% to 15% by weight of the total composition of a solvent, or mixtures there.

Suitable solvents for use herein include ethers and diethers having from 4 to 14 carbon atoms, preferably from 6 to 12 carbon atoms, and more preferably from 8 to 10 carbon atoms, glycols or alkoxylated glycols, glycol ethers and/or derivatives, polyols, alkoxylated aromatic alcohols, aromatic alcohols, aliphatic branched or linear alcohols, alkoxylated aliphatic branched or linear alcohols, terpenes, and mixtures thereof.

Suitable glycols for use herein are according to the formula HO—CR₁R₂—OH wherein R₁ and R₂ are independently H or a C₂-C₁₂ saturated or unsaturated aliphatic hydrocarbon chain and/or cyclic. Suitable glycols to be used herein are dodecaneglycol, 1,2-hexanediol and/or propanediol.

Suitable alkoxylated glycols for use herein are according to the formula R-(A)ₙ-R₁—OH wherein R is H, OH, a linear saturated or unsaturated alkyl of from 1 to 20 carbon atoms, preferably from 2 to 15 and more preferably from 2 to 10, wherein R₁ is H or a linear saturated or unsaturated alkyl of from 1 to 20 carbon atoms, preferably from 2 to 15 and more preferably from 2 to 10, and A is an alkoxy group preferably ethoxy, methoxy, and/or propoxy and n is from 1 to 5, preferably 1 to 2. Suitable alkoxylated glycols to be used herein are methoxy octadecanol and/or ethoxyethoxyethanol.

Suitable glycol ethers and/or derivatives thereof for use herein include monoglycol ethers and/or derivatives thereof, di-, tri- and poly-glycol ethers and/or derivatives thereof and mixtures thereof.

Suitable monoglycol ethers and derivatives thereof for use herein include propylene glycol butyl ether, and water-soluble CELLOSOLVE® solvents or mixtures thereof. Preferred Cellosolve® solvents include 2-(Hexyloxy)ethanol (i.e., 2-hexyl Cellosolve®), ethylene glycol ethyl ether (i.e., 2-ethyl Cellosolve®), ethylene glycol butyl ether (i.e., 2-butyl Cellosolve®) or mixtures thereof.

Suitable polyglycol ethers and derivatives thereof for use herein include n-butoxypropoxypropanol (n-BPP), butyl triglycol ether (BTGE), butyl diglycol ether (BDGE), diethylene glycol butyl ether, water-soluble CARBITOL® solvents or mixtures thereof.

Preferred water-soluble CARBITOL® solvents are compounds of the 2-(2-alkoxy ethoxy)ethanol class, 2-(2-alkoxy ethoxy)propanol class and/or 2-(2-alkoxy ethoxy)butanol class wherein the alkoxy group is derived from ethyl, propyl, butyl and tert-butyl. A preferred water-soluble carbitol is 2-(2-butoxyethoxy)ethanol also known as butyl carbitol®.

Suitable polyols for use herein are aliphatic linear or branched saturated or unsaturated hydrocarbons having from 2 to 12 carbon atoms, preferably 4 to 10, and comprising at least 2 hydroxyl groups, preferably from 2 to 4. Suitable polyols herein are diols such as 2-ethyl-1,3-hexanediol, 2,2,4-trimethyl-1,3-pentanediol, methyl-2,4 pentanediol, 1,6-hexanediol or mixture thereof.

Suitable alkoxylated aromatic alcohols for use herein are according to the formula R (A)ₙ-OH wherein R is an alkyl substituted or non-alkyl substituted aryl group of from 1 to 20 carbon atoms, preferably from 2 to 15 and more preferably from 2 to 10, wherein A is an alkoxy group preferably butoxy, propoxy and/or ethoxy, and n is an integer of from 1 to 5, preferably 1 to 2. Suitable alkoxylated aromatic alcohols are benzoxyethanol and/or benzoxypropanol.

Suitable aromatic alcohols for use herein are according to the formula R—OH wherein R is an alkyl substituted or non-alkyl substituted aryl group of from 1 to 20 carbon atoms, preferably from 1 to 15 and more preferably from 1 to 10. For example a suitable aromatic alcohol to be used herein is benzyl alcohol.

Suitable aliphatic linear or branched alcohols for use herein are according to the formula R—OH wherein R is a branched or linear saturated or unsaturated alkyl group of from 1 to 20 carbon atoms, preferably from 2 to 15 and more preferably from 2 to 12. Particularly suitable aliphatic branched alcohols to be used herein include 2-ethylbutanol and/or 2-methylbutanol. Particularly suitable aliphatic linear alcohols to be used herein include decanol, ethanol and/or 1- or 2-propanol.

Suitable alkoxylated aliphatic linear or branched alcohols for use herein are according to the formula R-(A)ₙ-OH wherein R is a branched or linear saturated or unsaturated alkyl group of from 1 to 20 carbon atoms, preferably from 2 to 15 and more preferably from 5 to 12, wherein A is an alkoxy group preferably butoxy, propoxy and/or ethoxy, and n is an integer of from 1 to 5, preferably 1 to 2. Suitable alkoxylated aliphatic branched alcohols include 1-methylpropoxyethanol and/or 2-methylbutoxyethanol. Suitable alkoxylated aliphatic linear alcohols include ethoxy propanol and/or propoxy propanol.

Other suitable solvents include ter amilic alcohol, terpene solvents and the like.

Suitable terpenes for use herein are mono-and bicyclic terpenes, especially those of the hydrocarbon class, which include the terpinenes, terpinolenes and pinenes and mixtures thereof. Highly preferred materials of this type are dipentene, alpha-pinene and/or beta-pinene. For example, pinene is commercially available from SCM Glidco (Jacksonville) under the name Alpha Pinene P&F®.

Particularly preferred solvents for use herein are ethylene glycol butyl ether, propylene glycol butyl ether, diethylene glycol butyl ether, butoxy propoxy propanol, butyl diglycol ether, benzyl alcohol, butoxypropanol, 2-(2-butoxyethoxy) ethanol, ethanol, methanol, benzyl alcohol, isopropanol, 1-propanol and mixtures thereof.

Thickening System

The compositions herein may comprise a thickener or a thickening system as a highly preferred optional ingredient.

Suitable thickeners herein are selected from the group consisting of organic thickeners, and inorganic thickeners and mixtures thereof.

Preferably the thickener herein when present, is an organic thickeners, more preferably a polyacrylate; a gum, which can be derived from marine sources (agar, alginates, carrageenan, furcellaran), terrestrial plants (guar gum, gum Arabic, gum tragacenth, karaya gum, locust bean gum and pectin), animal sources (gelatin), microbial polysaccharides (dextran, gellan gum, rhamsam gum, welan gum, Xanthan gum); a polysaccharide derivative (carboxymethylcellulose, methylhydroxypropyl cellulose, hydroxy propyl cellulose, hydroxyethyl cellulose, propylene glycol alginate, hydroxy propyl guar and modified starters); or a mixture thereof.

Other Suitable thickening systems are selected from the group consisting of a cationic/anionic surfactant system self-thickening systems.

Preferably, the compositions herein comprise a polyacrylate or a gum or a combination thereof .

The composition(s) herein may comprise from 0.005% to 15%, preferably from 0.01% to 10%, more preferably from 0.02% to 5% by weight of the total composition of a thickener or a thickening system.

The present invention also encompasses in a separate aspect a lavatory bowl rim-block comprising: at least one liquid composition; and a dispenser, said dispenser comprising at least one container and a dispensing means connected to said container(s) for dispensing said liquid composition onto a lavatory bowl surface; wherein said single liquid composition dispensed onto said lavatory bowl surface comprises gellan gum.

In this separate embodiment herein, said single liquid composition or said combination of compositions dispensed onto said lavatory bowl surface may comprise from 0.001% to 1%, preferably from 0.005% to 0.5%, more preferably from 0.001% to 0.2% by weight of the total composition of gellan gum

It has been found the use of gellan gum prevented leaking of the liquid formula from the dispenser onto the toilet bowl surface which most commonly is experienced by consumers during the in between flushes intervals. Gellan gum prevents leakage on the bowl without negatively affecting product release from the dispenser by providing a yield value on the fluid (e.g., the fluid behaves as a solid at very low stresses) whilst at the same time having no impact on the apparent viscosity of the fluid.

Perfumes

The composition(s) herein may comprise, as an optional ingredient, a perfume ingredient. The composition(s) herein may comprise from 0.01% to 40%, preferably from 0.01% to 35%, more preferably from 0.1% to 30%, and most preferably from 0.1% to 25% by weight of the total composition of said perfume ingredient.

Depending on the end use envisioned, the compositions according to the present invention may further comprise a variety of other ingredients including dyes, optical brighteners, builders, pigments, solvents, buffering agents, radical scavengers, polymers, stabilizers and the like.

### EXAMPLES

The following examples will further illustrate the present invention. The compositions are made by combining the listed ingredients in the listed proportions (weight % unless otherwise specified). Furthermore, the compositions comprise water and minors up to 100%. The following Examples are meant to exemplify compositions according to the present invention but are not necessarily used to limit or otherwise define the scope of the present invention.

The compositions are present in the container of a lavatory bowl rim-block comprising: at least one container; at least one liquid composition; and a dispensing means connected to at least one of said container(s) for dispensing a single liquid composition or a combination of liquid compositions onto a lavatory bowl surface.

I)

| Ingredients | Weight % |
|---|---|
| Kelzan T ® | 0.5 |
| Dobanol 91.8 ® | 15 |
| HLAS | 1 |
| Na HEDP | 0.5 |
| SF 1288 ® | 5.0 |
| Perfume | 12 |

pH of 6 adjusted with NaOH/H₂SO₄

II

| Ingredients | Weight % |
|---|---|
| Acusol 800S ® | 3 |
| Steol CS-330 ® | 20 |
| NaOH | 0.5 |
| DTPMP | 2 |
| DC193 ® | 10 |
| Perfume | 8 |

III

| Ingredients | Weight % |
|---|---|
| Natrosol HHR ® | 0.5 |
| Dobanol 91.8 | 1 |
| Daclor 70-3-23 ® | 15 |
| DTPA | 1.5 |
| DC 5220 ® | 7 |
| perfume | 10 |

IV

| Ingredients | Weight % |
|---|---|
| Kelzan T ® | 0.6 |
| Dobanol 91.8 ® | 20 |
| Silicone SF 1188 ® | 7 |
| Na2 HEDP | 2 |

V)

| Ingredients | Weight % |
|---|---|
| Natrosol HHR | 0.45 |
| Trilon FS ® | 1.3 |
| Silicone SF 1288 ® | 7.0 |
| Marlinat 242/90 ® | 10 |
| Nansa LSS 38/AS ® | 1 |
| Perfume | 5 |

VI

| Ingredients | Weight % |
|---|---|
| Acusol 800S ® | 0.5 |
| Perfume | 7 |
| ssEDDS | 0.5 |
| EMPICOL LX 28 ® | 20 |
| SF 1288 ® | 10 |

VII

| Ingredients | Weight % |
|---|---|
| Kelcogel F ® | 0.02% |
| Perfume | 7% |
| Marlinat 242/90 ® | 12 |
| Dobanol 91.8 ® | 2% |
| Kelzan T ® | 0.3% |

Dobanol® 23-3 is a C₁₂-C₁₃ EO3 nonionic surfactant, Dobanol® 45-7 is a C₁₄-C₁₅ EO7 nonionic surfactant, Dobanol® 91-8 is a C₉-C₁₁ EO8 nonionic surfactant and Dobanol® 91-10 is a C₉-C₁₁ EO10 nonionic surfactant, all commercially available from SHELL.

Na HEDP is Sodium ethane 1-hydroxy diphosphonate.

DTPMP is diethylene triamine penta methylene phosphonate.

DTPA is diethylene triamine pentaacetate.

ssEDDS is ethylenediamine N,N′-disuccinic acid.

SF 1288® and SF 1188® are Silicones-Polyethers copolymers, commercially available from GE Bayer Silicones.

Kelzan T® is Xanthan Gum and Kelcogel F® is gellan gum, both commercially available from CP-Kelco.

HLAS is a linear alkylbenzene sulphonic acid anionic surfactant.

DC 5220® and DC193® are silicone glycol polymers commercially available from Dow Corning.

Acusol 800S® is a hydrophobically-modified acrylate polymer commercially available from Rohm & Haas.

Natrosol HHR® is a hydroxycellulose commercially available from Hercules

Daclor 70-3-23® is a branched alkyl ethoxylated sulfate and Marlinat 242/90® is an alkyl ethoxylated sulfate, both are commercially available from Sasol.

Steol CS-330® is an alkyl ethoxylated sulfate commercially available from Stepan.

Trilon FS® is an amino carboxylate commercially available from BASF.

Nansa LSS 38/AS® is an alpha-olefin sulfonate and EMPICOL LX 28® is an alkyl sulfate, both are commercially available from Huntsman.

What is claimed is:

1. A lavatory bowl rim-block comprising: at least one liquid composition; and a dispenser, said dispenser comprising at least one container and a dispensing means connected to at least one of said container(s) for dispensing a single liquid composition or a combination of compositions onto a lavatory bowl surface; wherein said single liquid composition or said combination of compositions dispensed onto said lavatory bowl surface comprises a silicone polymer and a chelant.

2. A lavatory bowl rim-block according to claim 1, wherein said dispenser additionally comprises an attachment means, preferably said dispenser additionally comprises an attachment means and a supporting structure.

3. A lavatory bowl rim-block according to claim 2, wherein said attachment means attaches said dispenser to the rim of a lavatory bowl or suspends said dispenser from said rim, preferably said attachment means is a hook to suspend said dispenser from the rim of a lavatory bowl.

4. A lavatory bowl rim-block according to claim 1, wherein said chelant is selected from the group comprising phosphonate chelants, amino carboxylate chelants, other carboxylate chelants, polyfunctionally-substituted aromatic chelants, ethylenediamine N,N′-disuccinic acids, or mixtures thereof.

5. A lavatory bowl rim-block according to claim 1, wherein said chelant is a phosphonate chelant or a mixture thereof, preferably selected from the group consisting of ethane 1-hydroxy diphosphonates (HEDP) or salts thereof, alkylene poly (alkylene phosphonate), amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP) and mixtures thereof.

6. A lavatory bowl rim-block according to claim 1, wherein said chelant is ethane 1-hydroxy diphosphonate (HEDP) or a salt thereof.

7. A lavatory bowl rim-block according to claim 1, wherein said single liquid composition or said combination of liquid compositions dispensed onto said lavatory bowl surface comprise up to about 5% by weight of the total composition of a chelant.

8. A lavatory bowl rim-block according to claim 1, wherein said silicone polymer is a silicone glycol polymer.

9. A lavatory bowl rim-block according to claim 1, wherein said silicone polymer is a linear or grafted silicone glycol polymer according to the following formulae: 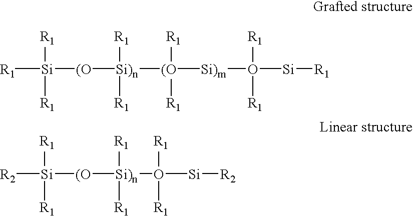
wherein: each R₁ independently is a hydrocarbon radical; R₂ is a group bearing a polyether functional group; n is an integer of from 0 to about 500; and for the grafted structure m is an integer of from about 1 to about 300, and preferably with n+m more than about 1.

10. A lavatory bowl rim-block according to claim 1, wherein said single liquid composition or said combination of liquid compositions dispensed onto said lavatory bowl surface comprise up to about 50% by weight of the total composition of said silicone glycol polymer.

11. A lavatory bowl rim-block according to claim 1, wherein said single liquid composition or said combination of liquid compositions dispensed onto said lavatory bowl surface additionally comprise a nonionic surfactant or mixtures thereof.

12. A lavatory bowl rim-block according to claim 11, wherein said single liquid composition or said combination of liquid compositions dispensed onto said lavatory bowl surface comprise up to about 50% by weight of the total composition of a nonionic surfactant or mixtures thereof.

13. A process of cleaning a lavatory bowl surface with a lavatory bowl rim-block according to claim 1, wherein said process comprises the step of applying a single liquid composition or a combination of liquid compositions onto a lavatory bowl surface.

14. A process of cleaning a lavatory bowl surface according to claim 13, wherein said application of a single liquid composition or a combination of liquid compositions onto a lavatory bowl surface is done upon flushing said lavatory bowl surface with water.

15. A lavatory bowl rim-block comprising: at least one liquid composition; and a dispenser, said dispenser comprising at least one container and a dispensing means connected to said container(s) for dispensing said liquid composition onto a lavatory bowl surface; wherein said single liquid composition dispensed onto said lavatory bowl surface comprises gellan gum.
